(19) United States
(12) Patent Application Publication
(10) Pub. No.: US 2026/0312837 A1
(43) Pub. Date: Oct. 8, 2026

(54) SERIAL BROADCAST READOUT IN A DAISY CHAIN NETWORK

(71) Applicant: ams-OSRAM International GmbH, Regensburg (DE)

(72) Inventors: Daniel DIETZE, Regensburg (DE); Markus KOESLER, Landshut (DE); Massimo RIGO, Trieste (IT); Matteo COLOMBO, Verrua Po (IT)

(21) Appl. No.: 19/482,803

(22) PCT Filed: Oct. 14, 2024
(86) PCT No.: PCT/EP2024/078879

§ 371 Date: Nov. 10, 2025

(30) Foreign Application Priority Data
Nov. 20, 2023 (DE) 102023132205.2

(51) Int. Cl. H04L 12/18; H04L 45/16

(52) U.S. Cl. CPC H04L 12/1854; H04L 45/16

(57) ABSTRACT

The present disclosure relates to a serial communication network with a plurality of network nodes having a primary node and a plurality of secondary nodes connected in a daisy chain configuration, wherein the network nodes are configured to communicate according to a wired communication protocol for serial communication; wherein the primary node includes control circuitry configured to: generate a broadcast readout message to prompt a single response from the plurality of secondary nodes; and cause a transmission of the broadcast readout message along the chain of secondary nodes; wherein each secondary node includes communication circuitry configured to: receive the broadcast readout message; and if a stop condition associated with the broadcast readout command is fulfilled at the secondary node, generate a response message and cause a transmission of the response message to the primary node.

### TECHNICAL FIELD

The present disclosure relates generally to a daisy chain network configured to implement a serial broadcast readout of a plurality of secondary network nodes, and to methods thereof (e.g., a method of performing serial broadcast readout of a plurality of secondary network nodes in a daisy chain network).

### BACKGROUND

In general, many applications are based on the interplay of interconnected devices that act in concert to provide a certain functionality. An example of such a system are the so-called “smart surfaces”, a new type of human machine interface (HMI) that find applications in particular in the automotive context and industrial context. In a “smart surface” hundreds of light emitting diodes (LEDs) are controlled to dynamically and adaptively show information to a user, and sensors and actuators allow capturing inputs and commands from the user. In a system including many interconnected devices, communication protocols may regulate the data transfer among devices, thus ensuring a reliable communication and avoiding potential conflicts. In particular, in the context of systems including sensors, actuators, light emitting devices, etc. the data transfer among devices may occur via a wired connection (e.g., via a single-wire or via a plurality of wires), so that the connected devices may communicate according to a wired communication protocol that defines the rules for transmitting data. Improvements in communication strategies for wired-based communication may thus be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1A and FIG. 1B show a serial network system having a daisy chain network topology, in a schematic representation according to various aspects;

FIG. 2A shows a network node, in a schematic representation according to various aspects;

FIG. 2B shows an exemplary configuration of the network node, in a schematic representation according to various aspects;

FIG. 2C shows an exemplary configuration of the input/output ports of the network node, in a schematic representation according to various aspects;

FIG. 2D shows an exemplary configuration of electrically conductive lines connected with the network node, in a schematic representation according to various aspects;

FIG. 3A to FIG. 3C illustrate a “serial readout with one response” approach, in a schematic representation according to various aspects;

FIG. 4A to FIG. 4C show schematic message flow diagrams associated with the “serial readout with one response” approach, according to various aspects;

FIG. 5A to FIG. 5C illustrate a “serial readout with many responses” approach, in a schematic representation according to various aspects; and

FIG. 6A and FIG. 6B show schematic message flow diagrams associated with the “serial readout with many responses” approach, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a daisy chain network, a network node, a communication circuitry). However, it is understood that aspects described in connection with methods may similarly apply to the devices, and vice versa.

In general, networks of interconnected devices that communicate with one another via a wired connection and according to a wired communication protocol play an important role in a variety of applications, such as in lighting systems, sensor systems, and the like. In this context, many communication protocols have been defined over the years to control the transfer of data among the networked devices. Broadly speaking, communication protocols may be divided in two main categories, parallel or serial. A parallel interface allows transferring multiple bits in parallel, whereas serial interfaces operate at a lower data rate (e.g., transferring a single bit at a time), e.g., considering the scenario of equal clock frequency.

With respect to parallel architectures, serial communication for a wired network may be implemented via a simpler setup (e.g., using a single wire, or in general less wires compared to parallel communication), and thus at a fraction of the cost. Serial communication may thus be of particular interest for wired network systems involving large numbers of interconnected devices.

Various options exist for serial network topologies, illustratively for the physical and/or logical arrangement of the nodes forming the communication network. The network topology may thus describe the path or paths available for a signal to travel through the network of interconnected nodes. In this context, the term “network node” may describe an electronic device that is part of the network. A “network node” may thus be an electronic device that includes communication circuitry to enable communication with other electronic devices (other nodes) that are part of the network. A “network node” may further include any suitable circuitry to implement additional functionalities, e.g. for carrying out a certain function or operation. As an example, considering a network of lighting fixtures, a network node may include light emitting circuitry configured to emit light. As another example, considering a network of sensor devices, a network node may include sensing circuitry configured to sense (or detect) a certain physical quantity such as temperature, light, mechanical vibrations, etc. A “network node” may also be referred to herein simply as “node”. It is understood that aspects described herein in relation to a “network node” may apply to the electronic device constituting that network node, and vice versa.

A simple network topology is the so-called “point-to-point topology”, in which exactly two nodes are directly connected (in other words linked) to one another. A further example may be the “star topology” in which each peripheral network node is connected to a central network node via an individual transmission line. A further example may be the “bus topology” in which the network nodes are connected to a common transmission line (illustratively, a common bus). In the “bus topology” several network nodes are connected at the same line providing a parallel connection of the network nodes. Further examples may be a “tree topology” or a “mesh topology”. So-called “hybrid topologies” that combine two or more types of topologies may also be provided.

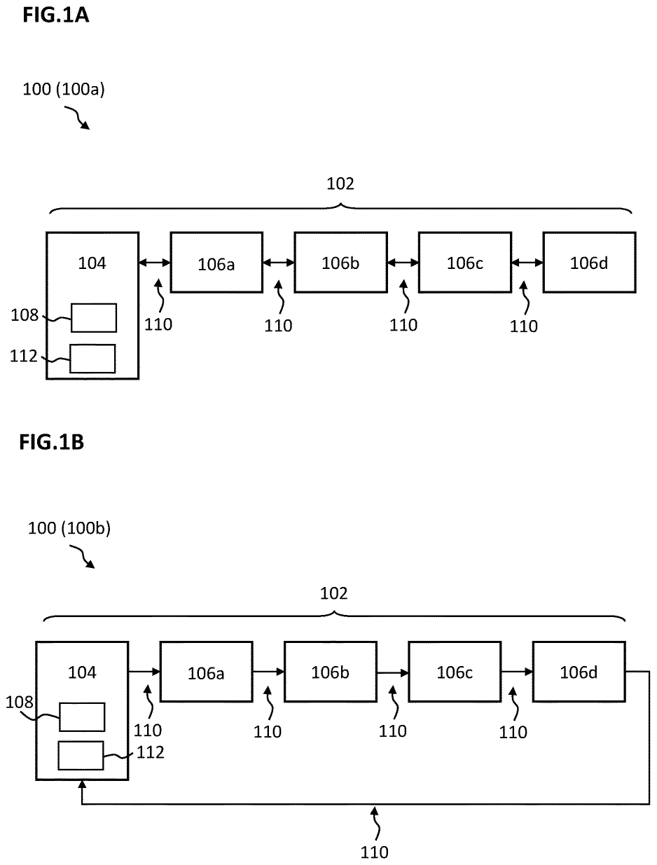

In this context, an advantageous network topology for interconnecting electronic devices is the so-called “daisy chain topology” (see also FIG. 1A and FIG. 1B). In a daisy chain configuration the network nodes may be connected to form a series of nodes, in which each network node may be connected via a point-to-point connection with one or two further network nodes, illustratively a preceding node and/or a subsequent node in the chain of serially connected nodes.

A “daisy chain topology” may be “linear”, such that a first node is connected to a second node, the second node is further connected to a third node, the third node is further connected to a fourth node, etc. until the final node of the series is reached. The “linear configuration” may thus be a bidirectional network configuration in which each network node is connected to the next in the series (illustratively, in a line, or chain), and the communication runs through the series of connected nodes and then returns along the same path. In this configuration the first node and the last node are not directly connected.

As another example a “daisy chain topology” may have a “ring configuration”, such that a first node is connected to a second node, the second node is further connected to a third node, the third node is further connected to a fourth node, etc. and the final node of the series is connected back to the first node. The “ring configuration” may thus define a loop-back network, in which the network nodes are connected in series, and the last node is connected back to the first node, so that communication runs through the sequence of nodes in one direction and then loops back to the first node. In the ring topology, every network node may thus be connected to two other nodes, with the first node and the last node being connected to one another.

A “daisy chain topology” may enable a cost-effective and scalable architecture for providing a network configured according to serial communication. In particular, a “daisy chain topology” may be realized with a reduced number of terminals and connection lines compared to other configurations, thus providing a cost- and resource-efficient implementation.

Therefore, wired networks having a daisy chain topology and based on serial communication are attractive for applications in which space and costs considerations may play an important role. In this framework, improved communication strategies for such type of networks may lead to a more cost- and resource-efficient operation, thus facilitating the integration of such systems in a variety of application scenarios.

In general, many communication protocols exist for governing wired-based serial communication. As a trait common to many communication protocols, wired-based serial communication may involve one network node acting as “primary node” and one or more other network nodes acting as “secondary nodes”.

In this context, the term “primary” may be used to describe the network node (illustratively, the corresponding electronic device) configured to control the operation of the other network nodes. The “primary node” may thus be configured to govern the transmission and the reception of data in the network, e.g. a “primary node” may be configured to transmit data to the one or more other “secondary nodes” and may be configured to request the transmission of data from the one or more other “secondary nodes”. A “primary node” may be understood as a device configured to instruct the operation of the one or more “secondary nodes” (e.g., providing instructions prompting the execution of one or more operations). A “primary node” may also be referred to herein as “master node”, “controller node”, “leader node”, or “host node”. In some aspects, a “primary node” may also be referred to herein as electronic control unit (ECU). As an example, a “primary node” may include a microcontroller or any other suitable control circuitry (e.g., a field programmable gate array, FPGA, an application specific integrated circuit, ASIC, etc.) to control the other nodes, e.g., to transmit instructions to the other nodes.

The term “secondary” may be used to describe a network node configured to be instructed by another network node, illustratively by the “primary node”. A “secondary node” may be a network node configured to receive instructions and to respond to the received instructions (e.g., without performing any active data transmission in absence of a prompt from the primary node). In some aspects, a “secondary node” may be configured to transmit data (e.g., various types of information), e.g. upon request from the primary node. A “secondary node” may also be referred to herein as “slave node”, “peripheral node”, “follower node”, or “responder node”.

In general, a wired communication protocol for serial communication may define a set of rules for controlling the data transfer among the network nodes. A wired communication protocol for serial communication may thus define the types of commands that may be sent/received, the types of responses to the different commands, the timing of the data transfer (e.g., synchronous or asynchronous), the layers for the communication, the type of coding for the data transfer, and the like. The type of node-to-node connection and the communication circuitry of a node may be adapted depending on the communication protocol according to which the nodes are configured, as in general known in the art.

Examples of communication protocols for wired-based serial communication may include the Inter-Integrated Circuit bus (I²C) protocol (e.g., according to I2C-bus specification and user manual Rev. 7.0 of 1 Oct. 2021), the Serial Peripheral Interface (SPI) protocol, the single-wire (1-wire, or one-wire) protocol, the Controller Area Network (CAN) protocol, the Ethernet protocol, and/or the microwire protocol.

Recently, a further communication protocol has been defined for wired-based serial communication, the so-called Open System Protocol (OSP). OSP may be used in a variety of implementations and has broad applicability. In one common implementation, OSP may be utilized in the context of a single microprocessor (as “primary node”) and multiple smart light emitting diode (LED) devices (as “secondary nodes”). The OSP defines a system architecture, commands, and data structure tailored to devices interconnected according to daisy chain network topology, and may thus enable a robust and efficient data transfer in such type of networks.

In general, in serial communication the readout of information from the secondary nodes requires the implementation of arbitration mechanisms for collision avoidance. However, arbitration mechanisms add significant overhead to the communication and limit the communication speed. Further, arbitration mechanisms may rely on at least two buffers to allow upstream and downstream messages to pass each other, which increases the circuit area and cost. Wired communication protocols may thus include an arbitration feature that effectively avoids collisions, but the overhead added is significant and prohibitive for certain relevant applications.

As a further consideration, serial chain protocols for lighting applications (e.g., the OSP protocol) are usually master-slave protocols without collision prevention mechanisms aimed at efficient and low-cost communication within a chain of network nodes, e.g., RGB light emitting diodes. In order to read out data from all nodes, every node is individually addressed. The next node may be addressed only after the response from the previous node has been received. Illustratively, for preventing collisions a direct reading of a single node at a time is allowed, so that the primary node sends a read request to a target secondary node, and waits until a response from the secondary node is received before sending a further request to a further secondary node. This adds a significant latency and limits the applicability of these protocols.

Aspects of the present disclosure may be related to readout strategies for retrieving data from the secondary nodes of a daisy chain network without having to rely on an arbitration mechanism and without the increased latency of other approaches. The readout strategies proposed herein may be based on controlling the way the secondary nodes respond to ensure collision avoidance, while allowing addressing a node without having to wait for the primary node to receive a response from a previous node.

In more detail, the proposed readout strategies may be based on causing an ordered stream of responses by the secondary nodes. The organization of the responses from the secondary nodes in an ordered sequence allows addressing all the secondary nodes at once, and then rely on the secondary nodes to decide when to send the own response message. In the proposed readout the message propagation and the timing over the chain is thus not coordinated centrally by the primary node but it is rather taken care of by the secondary nodes in the chain.

The secondary nodes may thus be addressed via a serial chain readout command that allows reading out all secondary nodes in the chain with a single command from the primary node. The readout may be an individual readout per node or a consolidated readout over the entire chain. The two possible readouts are referred herein as “serial broadcast with many responses” and “serial broadcast with one response”, respectively. A serial chain readout command may also be referred to herein as broadcast readout command.

The proposed strategies provides thus a flexible response configuration (e.g., with a message flow in the upstream or downstream direction along the chain), and provide the possibility of consolidated readouts. A “consolidated readout” may include a single response message to which a plurality of secondary nodes (e.g., each secondary node) contribute. A “consolidated readout” may allow for example determining a minimum value or maximum value of a certain operating parameter in the chain, such as a min/max temperature, a min/max voltage, and the like.

The readout described herein allows thus reading out all units in the chain with a single command from the primary node, thus reducing the communication time with respect to other approaches (e.g., by a factor VN, where N is the number of secondary nodes in the chain). As a further example, the proposed readout enables a convenient collection of min/max values over the chain. As another example, considering that the proposed readout has no need for additional buffers and collision avoidance mechanisms, the network may be implemented with a space- and cost-effective configuration, while obtaining a time-efficient communication. As an exemplary application, a daisy chain network configured to implement the readout proposed herein may be integrated in a “smart surface”.

In a preferred configuration, the network nodes of the daisy chain network may be configured to communicate with one another according to the Open System Protocol (e.g., according to OSIRE® E3731i—Open System Protocol 1.0, Application Note AN162 of 2023 Jul. 6). The OSP protocol may be particularly suitable for managing communication in daisy chain networks, e.g. in daisy chains of light emitting elements, and may thus constitute the most relevant use case for the proposed readout strategy.

Thus, in the present disclosure particular reference may be made to a daisy chain network in which the network nodes are configured to communicate with one another according to the Open System Protocol. In the following, use may be made of concepts and terminology that pertain to the OSP context. It is however understood that the aspects described herein may be broadly applied to other types of wired communication protocols for serial communication. Furthermore, some examples may refer to specific wired communication protocols (e.g., to a specific version or release of a wired communication protocol), but it is understood that the examples provided herein may be similarly applied to various other wired communication protocols or other versions/releases of the wired communication protocols, both existing and not yet formulated.

Further, in a preferred configuration the network nodes of the daisy chain network may include one or more light emitting elements (e.g., one or more light emitting diodes, LEDs). Illustratively, the proposed readout strategy may be of particular interest for efficiently reading data from all nodes in a daisy chain of RGB LEDs. This arrangement may be provided, for example, for a “smart surface” (e.g., in a vehicle). It is however understood that the configuration proposed herein may be applied to any suitable type of network node, e.g. to a network node configured to implement any suitable functionality.

FIG. 1A and FIG. 1B show a serial communication network 100 in a schematic representation, according to various aspects. In general, the serial communication network 100 may include a plurality of network nodes 102 disposed according to a daisy chain configuration. Illustratively, the network nodes 102 may be connected to form a series of network nodes, such that each network node 102 is connected with one or two other network nodes 102, and a data transfer within the network may include a propagation of the data from one network node 102 to the next node in the chain. In this regard, the serial communication network 100 may have a “linear” daisy chain topology, as shown for the configuration 100a in FIG. 1A, or a “ring” daisy chain topology, as shown for the configuration 100b in FIG. 1B.

According to the “linear” daisy chain topology, a first node 104 may be connected to a second node 106a, the second node 106a may be further connected to a third node 106b, etc. until a last node 106d is reached. As mentioned above, in this configuration the last node 106d and the first node 104 are not directly connected, and the communication between nodes may be bidirectional, thus allowing a flow of information from the first node 104 towards the last node 106d, and vice versa.

According to the “ring” daisy chain topology, the first node 104 may be connected to the second node 106a, the second node 106a may be further connected to the third node 106b, etc. until the last node 106d is reached. As mentioned above, in this configuration the last node 106d and the first node 104 may be directly connected, providing a loop-back arrangement. In this configuration, the communication between nodes may be unidirectional, thus allowing a flow of information from the first node 104 towards the last node 106d, and then a loop-back of the information from the last node 106d to the first node 104.

A serial communication network with a linear daisy chain topology, and a serial communication network with a ring daisy chain topology may be collectively referred to as serial communication network. A “serial communication network” may also be referred to herein as “wired communication network”, “daisy chain network”, or simply as “communication network” or “network”.

The exemplary configurations in FIG. 1A and FIG. 1B show a network 100 with five nodes 102, but it is understood that the network 100 may include any suitable number of nodes. As an example, the strategy proposed herein may be of particular relevance for networks including a relatively large number of nodes, e.g. the network 100 may include a number of network nodes 102 in the range from 100 to 5000, e.g. in the range from 200 to 2000, e.g. in the range from 300 to 1000.

According to various aspects, the network nodes 102 may include a primary node 104 and one or more secondary nodes 106a-106d (illustratively, a master node 104 and one or more slave nodes 106a-106d), e.g. a plurality of secondary nodes 106a-106d. As mentioned, the primary node 104 may govern the communication within the network 100. For example, the primary node 104 may include control circuitry 108 configured to control a communication within the network 100, e.g. configured to control a data transfer over the daisy chain of network nodes 102. Illustratively, the control circuitry 108 may be configured to cause a transmission of messages along the chain of secondary nodes 106a-106d, and to prompt a response from one or more of the secondary nodes 106a-106d. The primary node 104 may further include communication circuitry 112 to send/receive data to/from the chain of secondary nodes 106a-106d. As an exemplary realization, the primary node 104 may be or include a microcontroller, e.g. a microcontroller unit (MCU). In some aspects, the primary node 104 may be a unique node within the network 100. In some aspects, the primary node 104 may be further connected to a backbone network.

In general, each network node 102 may have a corresponding address associated therewith. The “address” of a node 102 may be a unique identifier of that node 102, and may allow delivering messages to that node 102. Illustratively, a message propagating along the chain of nodes 102 may include an address field including the address of the node 102 to which the message is addressed. Upon receiving a message, a node 102 may compare the address field of the message with its own address, and either execute an instruction contained in the message if the message is addressed for that node 102, or further propagate the message along the chain if the message is addressed to another node 102.

According to various aspects, each network node 102 may be aware of its respective position within the sequence of network nodes 102. With reference to the secondary nodes 106a-106d, the secondary node 106a connected with the primary node 104 may be the initial node of the sequence of secondary nodes, the secondary node 106d may be the final node of the sequence of secondary nodes (illustratively, an end-of-line, EOL, node), and the other secondary nodes 106b, 106c may be intermediate nodes between the initial node and the final node. Each secondary node 106a-106d may be aware of where the node is located within the sequence, e.g. at position one, two, three, etc. until the final position.

According to various aspects, neighboring network nodes 102 may be connected to one another via a wired connection 110. In this regard, the term “neighboring” or “adjacent” may be used to describe network nodes 102 at consecutive positions within the sequence of network nodes 102, illustratively logically adjacent network nodes 102, without implying a spatial relationship between the network nodes 102. In this framework, considering a certain node 102 as reference point, the term “next” or “subsequent” may be used to describe a further node 102 that is adjacent to the reference node, and is positioned downstream along the chain with respect to a direction of the data transfer. Thus, a message may propagate from the reference node to the next node, and then to a further next node and so on. In a corresponding manner, the term “previous” or “preceding” may be used to describe a further node 102 that is adjacent to the reference node, and is positioned upstream along the chain with respect to a direction of the data transfer. Thus, a message may propagate from the preceding node to the reference node.

The wired connection 110 may include one or more wires that electrically conductively connect one network node 102 with the neighboring network node(s) 102. Illustratively, a wired connection 110 may include one or more electrically conductive lines (e.g., electrically conductive wires, or electrically conductive traces). The wired connection 110 may illustratively be a serial bus to which the network nodes 102 are connected forming a chain. The number of electrically conductive lines of a wired connection 110 may be adapted according to the communication protocol via which the network nodes 102 communicate. In a preferred configuration, a wired connection 110 between neighboring nodes 102 may include exactly two electrically conductive lines. A configuration with two electrically conductive lines may allow implementing the OSP protocol, and may thus be particularly suitable for data transfer in a daisy chain network 100. It is however understood that in general a wired connection 110 may include any suitable number of electrically conductive lines, e.g. one, two, three, four, etc. In some aspects, a wired connection 110 may include at maximum four electrically conductive lines.

According to various aspects, the network nodes 102 may be configured to communicate with one another according to a wired communication protocol for serial communication (also referred to herein as base communication protocol). Illustratively, the network nodes 102 may be configured to transfer data along the chain of nodes according to rules and parameters defined by the wired communication protocol.

As mentioned, in a preferred configuration the network nodes 102 may be configured to communicate with one another according to the Open System Protocol, as this particular protocol may enable a robust communication in daisy chain networks, in particular for daisy chains of light emitters. It is however understood that the aspects described herein may broadly apply to a configuration in which the network nodes 102 communicate according to another type of wired communication protocol for serial communication.

In general, the details of the Open System Protocol are known in the art. An abridged overview is provided herein to introduce aspects relevant for the present disclosure. The OSP protocol may include a layer architecture with five layers, namely an application software layer, an application specific protocol layer, a network layer, a data link layer (DLL), and a physical (PHY) layer. The network layer may define commands conventions for interpreting the data. The DLL may describe the frame format and the encoding of messages according to the OSP protocol. The PHY layer may govern the actual transmission over the physical medium (illustratively, communication via the wired connection).

The OSP protocol may include 3 modes of communication, namely a low-voltage differential signaling mode (LVDS mode); an end of line (EOL) mode or microcontroller (MCU) mode; and a USE mode. Considering the configuration in which the network nodes communicate according to the OSP protocol, the aspects of the present disclosure may apply to each of the possible communication modes. In the OSP protocol, communication is message based, and a message may have a frame format. The frame may include different fields, namely a preamble, an address, a payload size indicator (PSI), a command, a payload, and a cyclic redundancy check (CRC). The fields of the frame may have different lengths (expressed in bits), and the message length may be variable (e.g., up to 12 bytes). For example, the preamble may be 4 bit long. The address may be 10 bit long and may indicate the address of the target node to which the message is addressed. The PSI may be 3 bit long and may indicate the length of the payload in bytes. The command may be 7 bit long, and commands may be device specific. The payload may have variable length in a range from 0 to 64 bit, as indicated by the PSI. The CRC may be 8 bit long and may include a checksum calculated over the full message excluding the CRC field. A message “field” may also be referred to herein as message “portion”.

According to the OSP protocol the primary node is able to identify the device type of each node in the chain. In this regard, each node may have a respective read-only identification code (e.g., 32 bit long). The read-only identification code may include information representing the node/device, such as device type (e.g., light emitting circuit, sensor, etc.), manufacturer, part identification, and part revision.

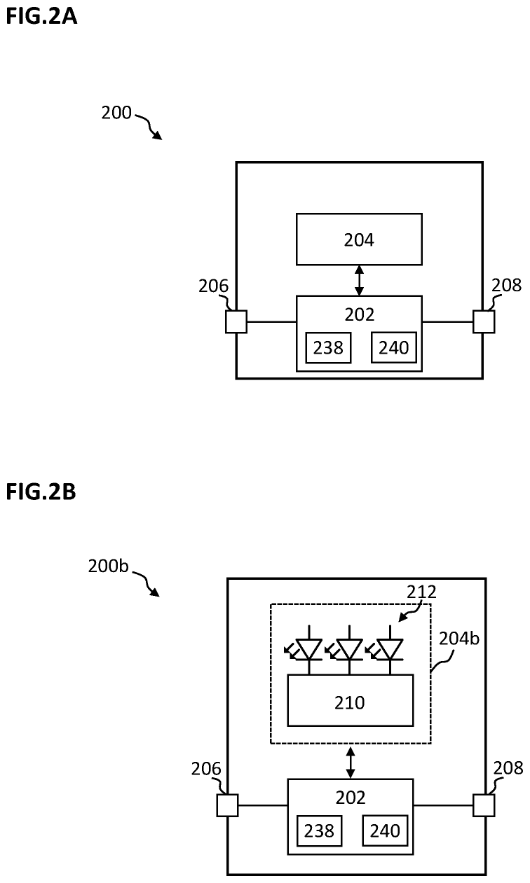

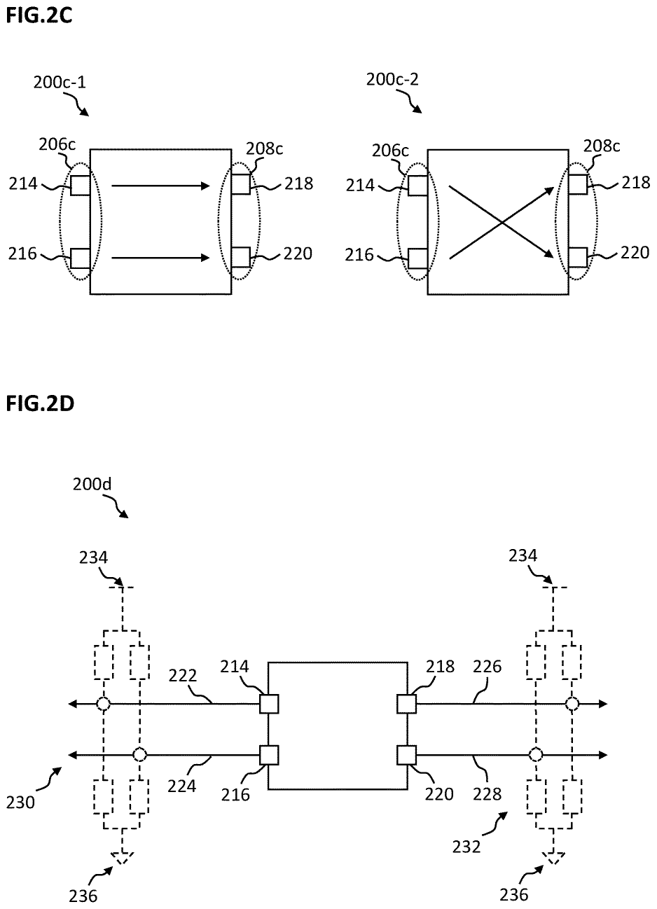

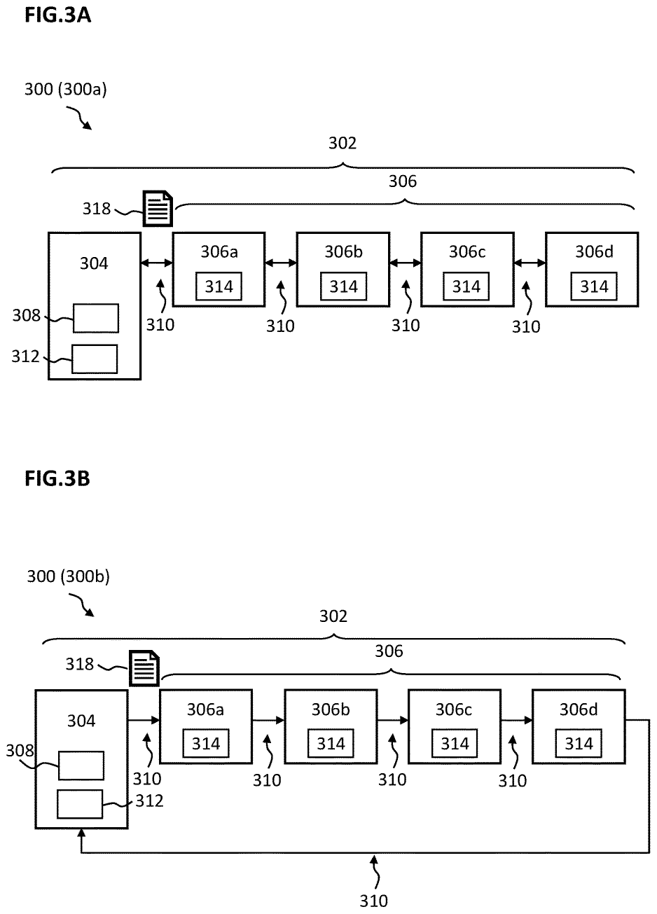

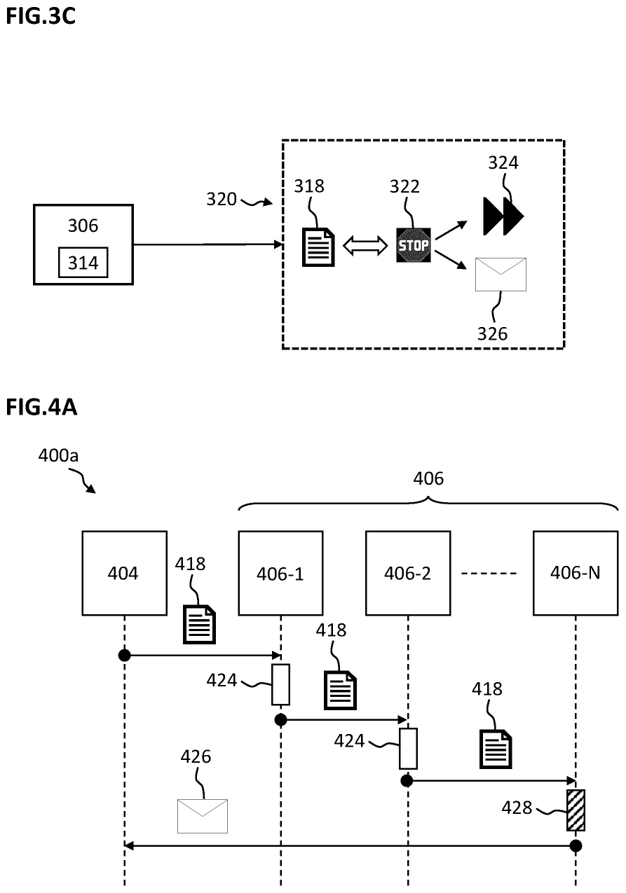

FIG. 2A shows a network node 200 in a schematic representation, according to various aspects. Illustratively, FIG. 2A shows an electronic device configured for use as network node in a serial communication network. The network node 200 may thus be a configuration of a network node 102 of the serial communication network 100 (e.g., a secondary node 106a-106d). It is understood that the representation of the network node 200 may be simplified for the purpose of illustration, and the network node 200 (electronic device) may include additional components with respect to those shown. An “electronic device” may also be referred to herein as electronic module.

In general, the network node 200 may include communication circuitry 202 configured to enable a communicative coupling of the network node 200 with a further electronic device (illustratively, with a further network node). The communication circuitry 202 may be configured to control a voltage level at the wired connection between the network node 200 and the further network node to encode data in the modulation of the voltage level. The communication circuitry 202 may include communication hardware 238 and a processor 240. The processor 240 may be configured to control the communication hardware 238 to implement the communication at the physical level, e.g. to control/define the voltage level at the wired connection. The processor 240 may be further configured to interpret (e.g., decode) messages received at the network node 200, and to generate corresponding response messages to be transmitted using the communication hardware 238. References herein to a configuration of the communication circuitry 202 of a network node 200 may correspondingly refer to a configuration of the communication hardware 238 (at a physical level) and/or processor 240 (at a logical level), as appropriate. As an exemplary realization the processor 240 may be a microprocessor.

In some aspects, a first voltage level at the wired connection (e.g., a high voltage level) may be associated with a logic “1”, and a second voltage level at the wired connection (e.g., a low voltage level) may be associated with a logic “0”. It is however understood that the definition of logic “1” and logic “0” and of the type of signal modulation associated thereto may be arbitrary (e.g., other examples of modulation may include the signal amplitude, the signal frequency, the signal period, etc.). A high voltage level may be understood as a signal having a voltage above a voltage threshold. A low voltage level may be understood as a signal having a voltage below a voltage threshold. Only as a numerical example, a high voltage level may be 1 V and a low voltage level may be 0 V. Considering a configuration according to the OSP protocol the network node 200 may support 3.3 V and 5 V logic levels.

As an exemplary realization, the communication circuitry 202 may include (as part of the communication hardware 238) one or more switch elements (e.g., one or more transistors) to selectively connect or disconnect an electrically conductive path between the wired connection and ground, and/or to selectively connect or disconnect an electrically conductive path between the wired connection and a supply voltage. The processor 240 may be configured to control the one or more switch elements to define the voltage level at the wired connection.

According to various aspects, the network node 200 may include a plurality of input/output ports 206, 208, and the communication circuitry 202 may be coupled with the input/output ports 206, 208. In operation, the network node 200 may receive data via a first input/output port 206, 208 and output data via a second input/output port 206, 208. The propagation direction of the data may vary depending on the configuration of the daisy chain network and depending on the node to which the data are addressed. Illustratively, each input/output port 206, 208 may be configured for coupling with a wired connection (e.g., with one or more electrically conductive lines), and the communication circuitry 202 may be coupled with the wired connection through the input/output port 206, 208. An exemplary configuration for the input/output ports 206, 208 will be described in FIG. 2C.

The network node 200 may further include functional circuitry 204 configured to implement a primary function of the network node 200. Illustratively, the network node 200 may in general be designed to carry out a certain operation, and the communication circuitry 202 may allow interconnecting the network node 200 with other network nodes to exploit its operation in cooperation with the other devices.

The functional circuitry 204 may have any suitable configuration and include any suitable components depending on the intended use of the network node 200. In a preferred configuration, as shown in FIG. 2B, a network node 200b may include (as functional circuitry 204b) light emitting circuitry, e.g. a driver circuit 210 and one or more light emitting elements 212. The driver circuit 210 may be configured to control a light emission by the one or more light emitting elements 212.

In principle, the light emitting elements 212 may be of any suitable type. Considering the context of integrated circuits, the light emitting elements may be or include light emitting diodes (LEDs), e.g. the one or more light emitting elements 212 may include at least one light emitting diode. As another example, the light emitting elements 212 may be or include laser diodes, e.g. edge emitting laser diodes or vertical cavity surface emitting laser diodes.

The light emitting elements 212 (e.g., the LEDs) may be configured to emit light having a predefined wavelength, for example in the visible range (e.g., from about 380 nm to about 700 nm), infrared and/or near-infrared range (e.g., in the range from about 700 nm to about 5000 nm), or ultraviolet range (e.g., from about 100 nm to about 400 nm). In some aspects, the light emitting elements 212 may be configured to emit light in different wavelength ranges. For example a first light emitting element 212 may be configured to emit light in a first wavelength range (e.g., a first color, for example blue), a second light emitting element 212 may be configured to emit light in a second wavelength range (e.g., a second color, for example red), and a third light emitting element 212 may be configured to emit light in a third wavelength range (e.g., a third color, for example green), etc.

It is understood that in other aspects an electronic device for use as a node in a daisy chain network may include a different type of functional circuitry 204. As another example, the network node 200 may include (as functional circuitry 204) sensor circuitry configured to sense a physical quantity, e.g. temperature, humidity, light, vibrations, etc. It is also understood that the functional circuitry 204 (e.g., the light emitting elements 212) may be integrated within the network node 200 or, in other aspects, the network node 200 may be configured to be coupled with functional circuitry 204 disposed externally to the network node 200. Illustratively, in this other scenario the network node 200 may include one or more terminals configured to allow a coupling of the network node 200 with the functional circuitry 204 (e.g., the light emitting elements 212) that is externally coupled with the network node 200. For example, the network node 200 may include circuitry configured to drive the external functional circuitry, e.g., a driving circuit for driving light emission by the externally connected light emitting elements 212.

The functional circuitry 204 may be communicatively coupled with the communication circuitry 202. The communication circuitry 202 (e.g., the processor 240) may thus be configured to deliver instructions to the functional circuitry 204 (received from the primary node of the network) and/or to receive information from the functional circuitry 204. For example, the communication circuitry 202 may receive status information from the functional circuitry 204, e.g. representative of operating parameters, of a current operation status (e.g., active, idle), the result of a sensing process, and the like.

According to various aspects, the network node 200 may further include a memory (not shown). The memory may be configured to store data and instructions for an operation of the network node 200. For example, the memory may be configured to store communication parameters for the communication circuitry 202 to carry out the communication via the wired connection. As another example, the memory may be configured to store instructions for operating the functional circuitry 204.

FIG. 2C shows exemplary configurations for the input/output ports 206c, 208c of the network node 200. According to various aspects, the network node 200 may include two identical input/output ports 206c, 208c, each including two input/output pins 214, 216, 218, 220. This configuration may be provided for communication according to the OSP protocol. It is however understood that in other aspects the input/output ports 206, 208 of the network node 200 may have a different configuration depending on the specific communication protocol used.

Two configurations may be provided. A first configuration 200c-1 may provide a symmetric alignment, in which a first input/output pin 214 of the first input/output port 206c may be coupled with a corresponding first input/output pin 218 of the second input/output port 208c, and a second input/output pin 216 of the first input/output port 206c may be coupled with a corresponding second input/output pin 220 of the second input/output port 208c. Considering the OSP protocol, the symmetric configuration may be provided, for example, when inter-node connectivity is realized via LVDS.

A second configuration 200c-2 may provide a crossed alignment, in which the first input/output pin 214 of the first input/output port 206c may be coupled with the second input/output pin 220 of the second input/output port 208c, and the second input/output pin 216 of the first input/output port 206c may be coupled with the first input/output pin 218 of the second input/output port 208c. Considering the OSP protocol, the crossed configuration may be provided, for example, when inter-node connectivity is realized via USE mode.

FIG. 2D shows an exemplary configuration for connecting the network node 200d to electrically conductive lines 222, 224, 226, 228. As shown, the first input/output pin 214 of the first input/output port may be connected to a first electrically conductive line 222, the second input/output pin 216 of the first input/output port may be connected to a second electrically conductive line 224, the first input/output pin 218 of the second input/output port may be connected to a third electrically conductive line 226, and the second input/output pin 220 of the second input/output port may be connected to a fourth electrically conductive line 228.

The electrically conductive lines 222, 224, 226, 228 associated with each of the pins 214, 216, 218, 220 may be connected to a pull-up resistor or a pull-down resistor, such as depicted in 230, wherein the first transmission line 222 is connected to a pull-up resistor and the second transmission line 224 is connected to a pull-down resistor, and in 232 wherein the third transmission line 226 is connected to a pull-up resistor and the fourth transmission line 228 is connected to a pull-down resistor. Naturally, this configuration is given for demonstrative purposes, and the polarities of the pins and corresponding lines may be reversed as desired for a given implementation. The resistance of the various pull-up resistors and pull-down resistors depends at least on the type of signal encoding used, the magnitude of the supply voltage, and the range of voltage used for signal transmission. Only as a numerical example the pull-up resistors and pull-down resistors may each be approximately 10 kΩ. The resistors may couple the electrically conductive lines 222, 224, 226, 228 with a supply voltage 234 (illustratively, with a supply terminal configured to be coupled with a supply source) and/or with ground 236 (illustratively, a ground terminal), thus enabling a modulation of the voltage level at the electrically conductive lines 222, 224, 226, 228.

As mentioned above, aspects of the present disclosure may be related to readout strategies that focus on the role of the secondary nodes of a daisy chain network rather than on a centralized control by the primary node. The readout proposed herein may thus include configuring the secondary nodes in the daisy chain such that in response to a broadcast readout command from the primary node an ordered (collision-free) stream of response messages is obtained.

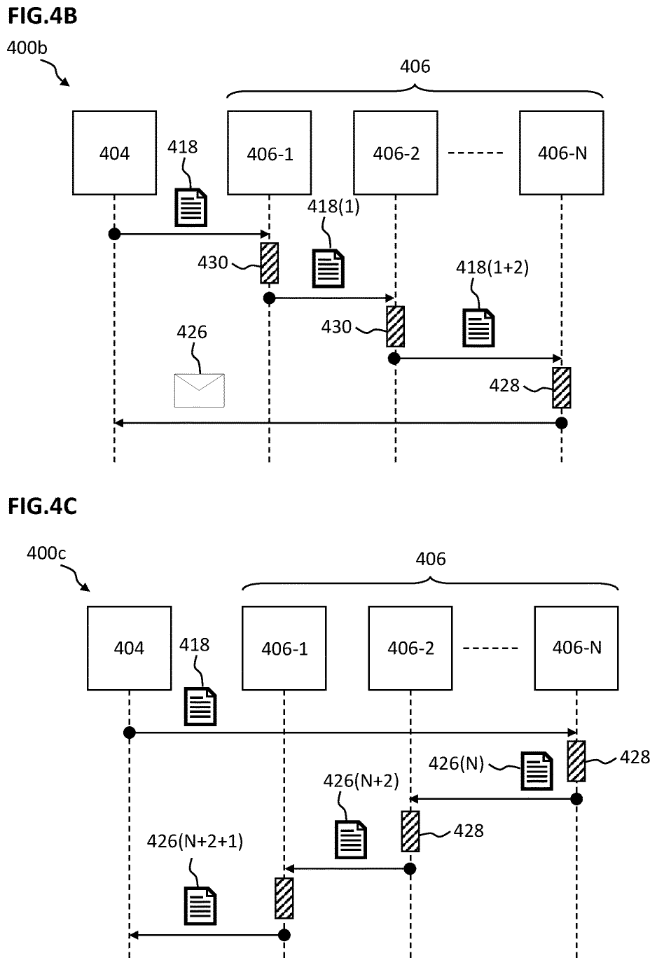

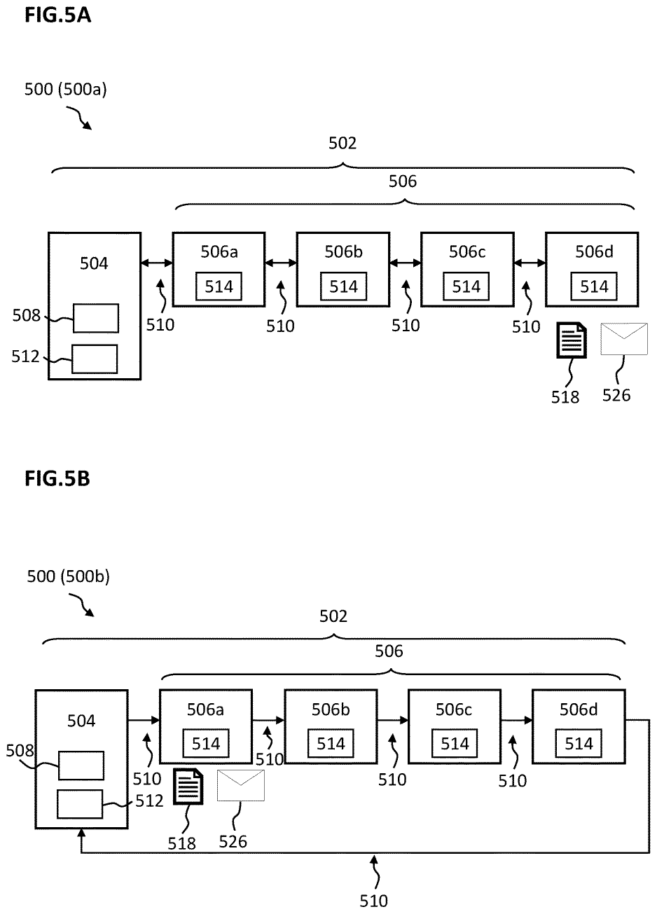

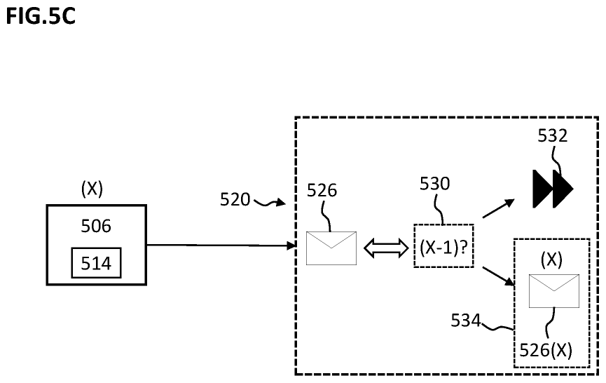

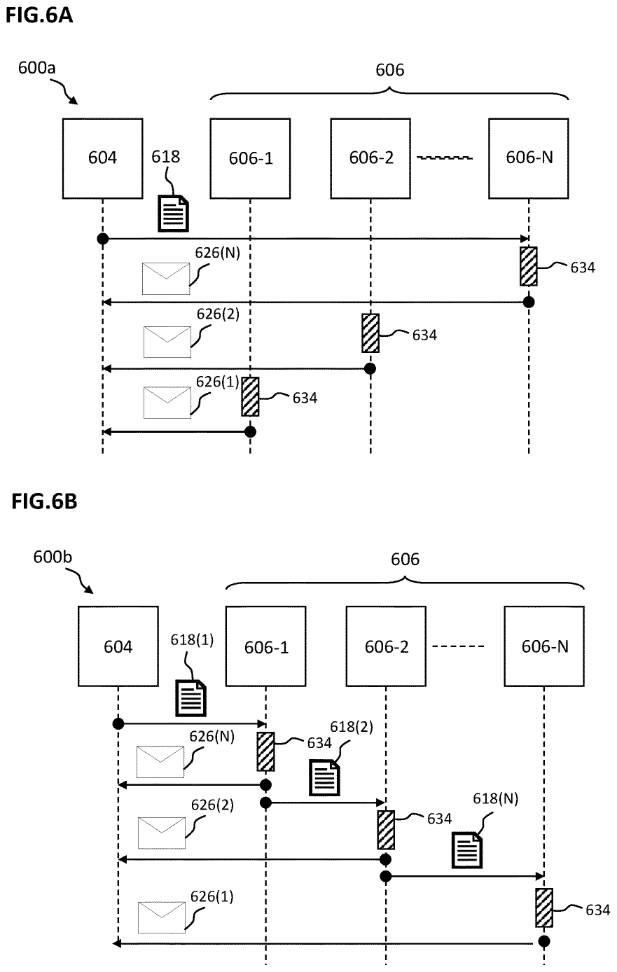

The proposed readout may be adapted to obtain a single response message from all the secondary nodes, e.g. as consolidated readout, or to obtain a response message from each of the secondary nodes. In the following the two possible configurations will be described separately to highlight the peculiar characteristics of each type of readout. In this regard, FIG. 3A to FIG. 4C are related to the “serial broadcast with one response” configuration, and FIG. 5A to FIG. 6B are related to the “serial broadcast with many responses” configuration. It is however understood that the two readouts are not mutually exclusive, and both configurations may be combined within a daisy chain network, i.e. a secondary node may be configured to respond according to the “one response” configuration and/or according to the “many responses” configuration depending on the command generated by the primary node.

In general, the proposed readout may include the primary node transmitting a broadcast readout message to the chain of secondary nodes, and the broadcast readout message may cause the secondary nodes to react according to the “one response” configuration or to the “many responses” configuration depending on the instructions included in the broadcast readout message. The broadcast readout message may include, for example, a first broadcast readout command to prompt a single (unique) response from the plurality of secondary nodes, or a second broadcast readout command to prompt a respective response from each of the secondary nodes. The first type of broadcast readout command may also be referred to herein as “serial single response command” or “single response command”. The second type of broadcast readout command may also be referred to herein as “serial multi-response command” or “multi-response command”. Considering the exemplary OSP case, a “message” may be referred to as “telegram”.

The specific configuration of the broadcast readout command itself may be freely adapted, e.g. depending on the type of communication protocol according to which the network nodes communicate. Thus, properties such as encoding, bit length, timing, etc. may be adapted to any suitable configuration. It is in general assumed that a secondary node (e.g., the processor of the corresponding communication circuitry) is capable of interpreting the broadcast readout command and carrying out a corresponding process in response to receiving the broadcast readout command.

FIG. 3A to FIG. 3C illustrate the “serial broadcast with one response” approach in relation to a serial communication network 300. The serial communication network 300 may in general be configured as the serial communication network 100 described in relation to FIG. 1A and FIG. 1, and may include a plurality of network nodes 302 with a primary node 304 and one or more secondary nodes 306, e.g. a plurality of secondary nodes 306. The network nodes 302 may be disposed in a daisy chain configuration and may be connected to one another via a wired connection 310. The primary node 304 may include control circuitry 308 to control a communication over the network 300, and communication circuitry 312 to send/receive messages. The secondary nodes 306 may include communication circuitry 314 to communicate via the wired connection 310. The network nodes 302 may in general be configured as the network node 200 described in relation to FIG. 2A to FIG. 2D. The “serial broadcast with one response” may apply both to a linear daisy chain network 300a and to a ring daisy chain network 300b. Further, the exemplary configurations in FIG. 3A and FIG. 3B show a network 300 with five nodes 302, but it is understood that the network 300 may include any suitable number of nodes.

As mentioned, in a preferred configuration the network nodes 302 may be configured to communicate with one another according to the OSP protocol, but the aspects discussed in relation to the “serial broadcast with one response” may broadly apply to other wired communication protocols for serial communication. Further, in a preferred configuration at least one secondary node 306 (e.g., a subset of secondary nodes 306, e.g. each secondary node 306) may be configured as the network node 200b in FIG. 2B, e.g. may include a driver circuit and one or more light emitting elements, e.g. one or more LEDs. It is however understood that the aspects discussed in relation to the “serial broadcast with one response” may broadly apply to other types of secondary nodes (e.g., sensors, actuators, and the like).

In this scenario, the communication circuitry 314 of each secondary node 306 may be configured to carry out a method 320 of serial broadcast readout in response to receiving a broadcast readout message 318, as shown in FIG. 3C. It is understood that the aspects discussed in relation to a configuration of a primary node 304 or secondary node 306 may apply in a corresponding manner to the method 320, and vice versa.

The control circuitry 308 of the primary node 304 may generate the broadcast readout message 318 and cause a transmission of the broadcast readout message 318 (via the communication circuitry 312) along the daisy chain of secondary nodes 306. The broadcast readout message 318 may include a (first) broadcast readout command. Considering the “one response” scenario, the broadcast readout command may be of a “first type” and may be configured to prompt a single response from the secondary nodes 306. Illustratively, the (first) broadcast readout command may be configured such that the propagation of the broadcast readout message 318 along the chain of secondary nodes 306 causes a single response message to be returned to the primary node 304. Thus, in response to the broadcast readout message 318 the plurality of secondary nodes 306 will deliver a single response message to the primary node 304. Considering the OSP protocol, the broadcast readout command may be included in the command portion of the frame structure of the broadcast readout message 318.

In this scenario, the address portion of the broadcast readout message 318 may be free of a specific address, illustratively the primary node 304 may refrain from indicating in the address portion the address of a target secondary node, because the triggering of a response is rather based on the fulfillment of a “stop condition”, as discussed in further detail below.

The communication circuitry 314 (e.g., the corresponding processor) of each secondary node 306 may be configured to carry out the method 320 upon receiving the broadcast readout message 318. The communication circuitry 314 of a secondary node 306 may thus be configured to receive the broadcast readout message 318 and carry out any necessary operation to interpret the broadcast readout message 318, e.g. a decoding of the broadcast readout message 318.

The communication circuitry 314 may be configured to determine whether a stop condition 322 associated with the broadcast readout message 318 is fulfilled. Stated in a different fashion, the communication circuitry 314 may evaluate the fulfillment of a stop condition 322 associated with the broadcast readout message 318. The stop condition 322 may include any suitable type of condition that prompts the currently active secondary node 306 to stop forwarding the broadcast readout message 318 and generate a response message 326. By way of illustration, the “stop condition” 322 may include a condition (a status) of the secondary node 306 that fulfills a stop criterion for interrupting the propagation of the broadcast readout message 318 along the chain of secondary nodes 306.

For example, the stop condition 322 may include the reaching of an end of line of the daisy chain of secondary nodes 306. In the exemplary configuration in FIG. 3A and FIG. 3B such “end of line” condition may be fulfilled at the final node 306d of the chain. As mentioned above a secondary node 306 may be aware of its position within the sequence of secondary nodes 306, so that the secondary node 306 may know whether it is located at the “end of line” or not. In this case, the stop condition 322 may be fulfilled if the secondary node 306 currently receiving and processing the broadcast readout message 318 is the final node 306d of the chain, and may be not fulfilled if the secondary node 306 currently receiving and processing the broadcast readout message 318 is another node 306a-306c of the chain (e.g., the initial node 306a, or an intermediate node 306b, 306c).

As another example, the stop condition 322 may include a stop event being pending at the secondary node 306. A “pending event” may include any change in a status of the secondary node 306 being of interest for the primary node 304. Illustratively, in this case the stop condition 322 may include the occurrence of a change in a status of the secondary node 306. In this case, the stop condition 322 may be fulfilled if there is a stop event pending at the secondary node 306 currently receiving and processing the broadcast readout message 318, and may be not fulfilled if there is no stop event pending at such secondary node 306.

An example of “pending event” may be a failure flag being active at the secondary node 306, e.g. a flag indicative of a failure at the secondary node 306 (for example, a failure of the functional circuitry of the node). As another example, a “pending event” may be a diagnostic flag being active at the secondary node 306, e.g. a flag indicative of one or more operating parameters being outside of an expected range (without a failure yet). An example of “diagnostic flag” may be “temperature raised above a threshold”, or “voltage raised above a threshold”, and the like. A further example of “pending event” may be a report flag being active at the secondary node 306, e.g. a flag indicative of information to be reported from the secondary node 306 to the primary node 304. This may be the case, for example, if a sensor attached to (or included in) the secondary node 306 has finished a long measurement or reports crossing of a threshold (for instance, a sensor detects that a door has been opened, etc.).

According to various aspects, the broadcast readout message 318 may specify the relevant stop condition 322, illustratively the stop condition 322 to be evaluated for the current iteration of the serial broadcast readout with one response. As an example, the broadcast readout message 318 may include information representative of the stop condition 322 in a command portion or data portion (e.g., payload portion) of the frame structure of the broadcast readout message 318. The control circuitry 308 of the primary node 304 may select the type of stop condition 322 and provide corresponding information in the broadcast readout message 318.

The communication circuitry 314 may be further configured to generate a response message 326 addressed to the primary node 304 if the stop condition 322 is fulfilled (at the currently active secondary node 306). Illustratively, the fulfillment of the stop condition 322 may cause the communication circuitry 314 (e.g., the processor) of the secondary node 306 to generate a corresponding response message 326 to respond to the readout request from the primary node 304. For example, communication circuitry 314 may set the address of the primary node 304 in an address portion of the response message 326.

The content of the response message 326 may vary depending on the scenario, e.g. depending on the type of stop condition 322. For example, the response message 326 may include information representative of a failure at the secondary node 306, e.g. describing the likely cause of the failure, which components are malfunctioning, etc. As another example, the response message 326 may include information representative of one or more operating parameters of the secondary node 306, such as a temperature, a voltage, a current, and the like. As a further example, the response message 326 may include information representative of the result of a process carried out at the secondary node 306, e.g. the result of a sensing process. The content of the response may be included in a data portion (e.g., a payload portion) of the response message 326.

The communication circuitry 314 may be further configured to cause a transmission of the response message 326 to the primary node 304. Illustratively, after having generated the response message 326, the communication circuitry 314 of the active secondary node 306 may initiate the transmission of the response message 326 along the daisy chain until the response message 326 reaches the primary node 304. Considering the linear daisy chain 300a the response message 326 may propagate back along the chain, whereas in the ring daisy chain 300b the response message 326 may propagate forward and then loop-back from the last node 306d to the primary node 304.

The secondary node 306 that generated the response message 326 may thus transmit the response message 326 to a neighboring node 306 (via the wired connection 310, according to the wired communication protocol, e.g. OSP). The neighboring node 306 may receive the response message 326, determine that the response message 326 is addressed to the primary node 304, and forward the response message 326 along the chain in direction of the primary node 304. The forwarding of the response message 326 may be repeated until the response message 326 reaches the primary node 304.

The communication circuitry 314 may be further configured to forward 324 the broadcast readout message 318 to a neighboring secondary node 306 if the stop condition 322 is not fulfilled. Illustratively, if the communication circuitry 314 determines that a status of the secondary node 306 does not fulfill the stop condition 322, the communication circuitry 314 refrains from generating a response message 326 and rather transmits the broadcast readout message 318 further along the chain (to the adjacent secondary node 306). The broadcast readout message 318 may thus propagate along the chain until a certain condition is fulfilled, and the currently active node 306 stops the forwarding and returns the response 326 to the primary node 304.

As seen from the perspective of the method 320, the method 320 may include receiving, at a secondary node 306, a broadcast readout message 318. The broadcast readout message 318 may include a (first) broadcast readout command configured to prompt a single response from the plurality of secondary nodes 306. The method 320 may further include, determining (e.g., evaluating) at the secondary node 306 whether a stop condition 322 associated with the (first) broadcast readout command is fulfilled. The method 320 may further include generating, by the secondary node 306, a response message 326 if the stop condition 322 is fulfilled (or forwarding the broadcast readout message 318 to a neighboring secondary node 306 if the stop condition 322 is not fulfilled). The response message 326 may be addressed to the primary node 304, and the method 320 may further include causing by the secondary node 306 a transmission of the response message 326 to the primary node 304.

According to various aspects, a computer program product may be provided. The computer program product may store instructions which, when executed by a computer system (e.g., by the processor of the communication circuitry of a secondary node) cause the computer system to carry out the steps of the method 320. For example, the computer program product may be a non-transitory computer readable medium, e.g. part of a secondary node.

FIG. 4A to FIG. 4C show message flow diagrams 400a, 400b, 400c illustrating the “serial readout with one response” approach and possible additional configurations or modifications to the process described in relation to FIG. 3A to FIG. 3C. The aspects discussed in relation to FIG. 4A to FIG. 4C may thus be related to optional steps of the “serial readout with one response”, illustratively to possible configuration(s) of the communication circuitry 314 and possible steps of the method 320. The message flow diagrams 400a, 400b, 400c illustrate a scenario in which a primary node 404 transmits a broadcast readout message 418 with a broadcast readout command to prompt a single response message 426 from a plurality of secondary nodes 406, and possible actions carried out by the secondary nodes 406 in this context. The message flow diagrams 400a, 400b, 400c may apply both to a linear daisy chain topology and to a ring daisy chain topology.

The message flow diagram 400a in FIG. 4A illustrates the basic scenario discussed in relation to FIG. 3A to FIG. 3C. In brief, the primary node 404 generates and transmits the broadcast readout message 418 to the chain of secondary nodes 406. The active secondary node 406 (illustratively, the secondary node currently receiving/processing the broadcast readout message 418) evaluates the fulfillment of the stop condition associated with the broadcast readout message 418 and either carries out a forwarding 424 of the broadcast readout message 418, or a generating 428 of a response message 426 which then returns to the primary node 404. In the exemplary scenario in FIG. 4A, a first secondary node 406-1 may forward the broadcast readout message 418 (upon the stop condition not being fulfilled) to a second secondary node 406-2, the second secondary node 406-2 may further forward the broadcast readout message 418 along the chain (to a third secondary node), etc. until an N-th secondary node 406-N is reached, at which node 406-N the stop condition is fulfilled and a response message 426 is generated.

According to various aspects, as shown in the message flow diagram 400b in FIG. 4B, a secondary node 406 may modify the broadcast readout message 418 prior to forwarding it to the neighboring secondary node 406. Illustratively, upon determining that the stop condition is not fulfilled at the node 406, the communication circuitry of that secondary node 406 may be configured to change information included in the broadcast readout message 418 or add information to the broadcast readout message 418 prior to forwarding the (modified) broadcast readout message 418 to the subsequent node 406.

A secondary node 406 may modify the broadcast readout message 418 in relation to any suitable information. As an example, the modification of the telegram 418 may enable an auto-addressing function of the chain. In auto-addressing a secondary node 406 may auto-generate an own unique identifier or address. A secondary node 406 may retrieve from the broadcast readout message 418 address information representative of the address of the preceding node 406 in the chain, generate own address information based on the address information of the preceding node 406 (e.g., by incrementing the address by one unit), and insert the generated own address information in the broadcast readout message 418 prior to forwarding it to the subsequent node 406. The generated addresses may then be sent to the primary node 404, e.g. as part of the response message 426.

This scenario is illustrated in the message flow diagram 400b in FIG. 4B. In brief, the primary node 404 generates and transmits the broadcast readout message 418 to the chain of secondary nodes 406. The active secondary node 406 may modify the broadcast readout message 418 prior to forwarding the message 418 down the chain. The active secondary node 406 may thus carry out a modification 430 of the broadcast readout message 418 and forward a modified version of the broadcast readout message 418. For example, the first secondary node 406-1 may forward a first modified broadcast readout message 418(1), the second secondary node 406-2 may forward a second modified broadcast readout message 418(1+2) (illustratively, a further modified version of the first modified broadcast readout message 418(1)), and so on, until a node 406-N is reached where the stop condition is fulfilled and the response message 426 is generated.

According to various aspects, as shown in the message flow diagram 400c in FIG. 4C, the broadcast readout message 418 for single response may prompt a consolidated response from the plurality of secondary nodes 406. In this scenario, each secondary node 406 through which the response message 426 propagates may contribute to the final version of the response message 426 delivered to the primary node 404. This configuration may be particularly suitable to retrieve absolute information from the secondary nodes 406, e.g. to identify a minimum value or maximum value of some parameter.

In this scenario, the secondary node 406 that initially generates the response message 426 may be either the initial secondary node in the chain for a ring configuration, or the final secondary node in the chain in a linear configuration, thus ensuring that each node may receive and adapt the response message 426. It is however understood that in some aspects a subset of nodes may be considered, e.g. to evaluate a portion of the chain which may be relevant in a certain scenario, so that the secondary node 406 that initially generates the response message 426 may also be an intermediate node of the chain.

The communication circuitry of a secondary node 406 may thus be further configured to receive the response message 426 from the neighboring secondary node (upstream with respect to the direction towards the primary node 404), and modify the response message 426 prior to forwarding the (modified) response message 426 towards the primary node 404 (e.g., to the neighboring secondary node 406). In particular, the communication circuitry may replace (first) information contained in the response message 426 (e.g., in the payload portion) with (second) own information. The first information may be associated with another secondary node 406, e.g. the neighboring node 406 or another node 406 upstream in the chain. The second information may be representative of the active secondary node 406 that is carrying out the modification. According to various aspects, the active secondary node 406 may modify the information contained in the response message 426 if a corresponding replacement criterion is fulfilled. Illustratively, the communication circuitry may determine whether the own (second) information fulfills the replacement criterion, and carry out the replacement if the replacement criterion is fulfilled.

In a preferred configuration, the information to be evaluated/replaced may be representative of an operating parameter of a secondary node 406, such as an operating temperature, an operating voltage, an operating current, or any suitable quantifiable operating parameter of a secondary node 406 (e.g., of the respective functional circuitry). In this scenario the consolidated response may allow a time-efficient monitoring of the status of the entire chain. It is however understood that in principle also other types of information may be considered.

In this scenario, the (first) information associated with another secondary node 406 may include a (first) value of an operating parameter of the other secondary node 406, and the own (second) information may include a (second) value of an own operating parameter of the active secondary node 406. The replacement criterion may serve for example to determine an absolute minimum or absolute maximum value of the operating parameter in the chain.

For example, for determining an absolute minimum, the fulfillment of the replacement criterion may include the (second) value of the own operating parameter being less than the (first) value indicated in the response message 426. In this case if the own value is less than the already indicated value, the secondary node 406 may write its own value in the response message 426 and forward the (modified) response message 426 towards the primary node 404. If the own value is equal to or greater than the already indicated value, the secondary node 406 refrains from modifying the response message 426 and forwards the response message 426 without modification.

In a corresponding manner, for determining an absolute maximum, the fulfillment of the replacement criterion may include the (second) value of the own operating parameter being greater than the (first) value indicated in the response message 426. In this case if the own value is greater than the already indicated value, the secondary node 406 may write its own value in the response message 426 and forward the (modified) response message 426 towards the primary node 404. If the own value is equal to or less than the already indicated value, the secondary node 406 refrains from modifying the response message 426 and forwards the response message 426 without modification.

Thus, a node 406 receives the command (as part of the response message 426), compares the value of the parameter with the one stored in the message 426 and, if it is larger/smaller, replaces the payload with its own reading. For example, each node may include a LED driver and the maximum LED forward voltage across the chain is efficiently returned to the primary node (MCU). This may be used for optimizing the power consumption of the chain.

This scenario is illustrated in the message flow diagram 400c in FIG. 4C. In brief, the stop criterion is fulfilled at the N-th node 406-N which generates a first response message 426(N) including information related to the N-th node 406-N (e.g., the value of an operating parameter at the N-th node 406-N). The second secondary node 406-2 may receive the first response message 426(N) and, if the replacement criterion is fulfilled, carry out a modification 432 of the response message 426(N) to obtain a modified response message 426(N+2), in which the contributions of both the N-th node 406-N and second node 406-2 are considered. The same may happen at the first secondary node 406-1, which may deliver, as output, a further modified response message 426(N+2+1), thus providing a consolidated response from all the secondary nodes 406 in the chain.

FIG. 5A to FIG. 5C illustrate the “serial broadcast with many responses” approach in relation to a serial communication network 500. The serial communication network 500 may be configured as the serial communication network 100 described in relation to FIG. 1A and FIG. 1B, and may include a plurality of network nodes 502 with a primary node 504 and one or more secondary nodes 506, e.g. a plurality of secondary nodes 506. The network nodes 502 may be disposed in a daisy chain configuration and may be connected to one another via a wired connection 510. The primary node 504 may include control circuitry 508 to control a communication over the network 500, and communication circuitry 512 to send/receive messages. The secondary nodes 506 may include communication circuitry 514 to communicate via the wired connection 510. The network nodes 502 may in general be configured as the network node 200 described in relation to FIG. 2A to FIG. 2D. The “serial broadcast with many responses” may apply both to a linear daisy chain network 500a and to a ring daisy chain network 500b. Further, the exemplary configurations in FIG. 5A and FIG. 5B show a network 500 with five nodes 502, but it is understood that the network 500 may include any suitable number of nodes.

As mentioned, in a preferred configuration the network nodes 502 may be configured to communicate with one another according to the OSP protocol, but the aspects discussed in relation to the “serial broadcast with many responses” may broadly apply to other wired communication protocols for serial communication. Further, in a preferred configuration at least one secondary node 506 (e.g., a subset of secondary nodes 506, e.g. each secondary node 506) may be configured as the network node 200b in FIG. 2B, e.g. may include a driver circuit and one or more light emitting elements, e.g. one or more LEDs. It is however understood that the aspects discussed in relation to the “serial broadcast with many responses” may broadly apply to other types of secondary nodes (e.g., sensors, actuators, and the like).

Although being described separately, it is understood that the aspects discussed in relation to the network 500 and the “many responses” configuration may be combined with the aspects discussed in relation to the network 300 and the “single response” configuration. Illustratively, the primary node and secondary nodes may be configured to carry out only the “single response” approach, only the “many responses” approach, or both the “single response” approach and the “many responses” approach.

According to the “many responses approach” each secondary node 506 may be configured to generate an own response message 526 for the primary node 504 after each preceding secondary node in the chain generated and transmitted its own response message 526. Illustratively, in the “many responses configuration” the communication circuitry 514 of a secondary node 506 may be configured to generate an own response message 526 and cause the transmission of the own response message only after the node has forwarded the response messages 526 of all the preceding nodes in the chain.

In the “many responses” configuration, the communication circuitry 514 of each secondary node 506 may be configured to carry out a (second) method 520 of serial broadcast readout, as shown in FIG. 5C. It is understood that the aspects discussed in relation to a configuration of a primary node 504 or secondary node 506 may apply in a corresponding manner to the method 520, and vice versa.

The control circuitry 508 of the primary node 504 may generate the (second) broadcast readout message 518 and cause a transmission of the broadcast readout message 518 (via the communication circuitry 512) to a boundary secondary node 506 of the daisy chain, illustratively to the initial secondary node 506a of the chain or to the final secondary node 506d of the chain. Illustratively, the boundary secondary node 506 may be a node disposed at a boundary of the chain.

The initial secondary node 506a may be understood as the secondary node logically closest to the primary node 504, e.g. the node from which the primary node 504 receives messages in the linear configuration, or the node to which the primary node 504 transmits messages in the ring configuration. In a corresponding manner, the final (or last) secondary node 506d may be understood as the secondary node logically farthest away from the primary node 504 considering message transmission, e.g. the last node to receive a message originating from the primary node 504.

The broadcast readout message 518 may include a (second) broadcast readout command. Considering the “many responses” scenario, the broadcast readout command may be of a “second type” and may be configured to prompt a response from each of the secondary nodes 506. Illustratively, the (second) broadcast readout command may be configured to cause that each secondary node 506 sends an own response to the primary node 504. Thus, in response to the second type of broadcast readout message 518 the plurality of secondary nodes 506 will deliver a plurality of response messages to the primary node 504. Considering the OSP protocol, the broadcast readout command may be included in the command portion of the frame structure of the broadcast readout message 518. The delivery of the multiple responses is coordinated to avoid collision, as discussed in further detail below.

To send the broadcast readout message 518 to the target boundary node 506a, 506d, the control circuitry 508 of the primary node 504 may set the address of the target boundary node 506a, 506d in the address portion of the broadcast readout message 518, such that each other secondary node 506 forwards the broadcast readout message 518, and the target boundary node 506a, 506d accepts and processes the broadcast readout message 518.

In the linear daisy chain configuration 500a the target boundary node may be the last secondary node 506d of the chain. In the ring daisy chain configuration 500b the target boundary node may be the initial secondary node 506a of the chain. By way of illustration, the command may be addressed to the secondary node that should generate and transmit its own response first, and then the stream of responses proceeds further from each subsequent node in the chain until the secondary node that should generate and transmit its own response last is reached (i.e., the first node 506a in the linear case and the final node 506d in the ring case).

In this configuration, each secondary node 506 (being aware of its position in the chain) generates and transmits its own response only after the responses from all the preceding nodes in the chain have been generated and forwarded to the primary node 504 (all the nodes upstream considering the flow of messages towards the primary node 504).

The communication circuitry 514 of the boundary node receiving the broadcast readout message 518 may be configured to, in response to the broadcast readout message 518, generate a response message 526 addressed to the primary node 504, and cause a transmission of the response message 526 towards the primary node 504 along the chain of nodes 506. The content of the response message 526 may vary depending on the scenario and on the type of information requested by the primary node 504. As discussed in relation to FIG. 3A to 3C, the content of the response message 526 may include an operating parameter of the node, an operating status of the node, a result of a process carried out by the node, and the like. The response message 526 may also be referred to herein as “broadcast response message”.

The communication circuitry 514 of the boundary node 506a, 506d may be further configured to cause a transmission of the response message 526 to the primary node 504, illustratively a propagation of the response message 526 along the chain until the response message 526 reaches the primary node 504. Considering the linear daisy chain 500a the response message 526 may propagate back along the chain, whereas in the ring daisy chain 500b the response message 526 may propagate forward and then loop-back from the last node 506d to the primary node 504.

In the “many responses approach”, the communication circuitry 514 (e.g., the corresponding processor) of each secondary node 506 may be configured to receive a response message 526 to be forwarded in direction of the primary node 504. The communication circuitry 514 may determine (530) whether the response message 526 to be forwarded was generated by the immediately adjacent node in the chain. If the response message 526 originated from the immediately adjacent node, after having forwarded the response message 526, the communication circuitry 514 may generate (534) an own response message 526(X) and cause a transmission of the own response message 526(X) to the primary node 504. If the response condition is not fulfilled, i.e. if the response message 526 originated from another node further upstream in the chain, the communication circuitry 514 may simply forward (532) the response message 526 in direction of the primary node 504 while refraining from generating/transmitting the own response message 526(X).

The communication circuitry 514 may evaluate the fulfillment of the response condition based on information included in the response message, for example based on address information indicative of which secondary node 506 generated the response message 526. If the address information corresponds to the address of the immediately adjacent node, the communication circuitry 514 may determine that the response condition is fulfilled and generate/transmit the own response message 526(X).

In the “bidirectional mode” 500a, the command 518 may thus be sent to the last unit 506d in the chain, who returns its response 526 to the master 504. Each node 506 forwards the responses of all the preceding nodes 506 until it passed the response of its direct neighbor (address+1). This triggers the generation of its own response 526(X), which will be sent directly after all other messages have been forwarded. In the “loop-back mode” 500b, the command 518 may be sent to the first node 506a, which then forwards its response downstream. A node 506 is triggered to send its own response telegram once it forwarded the response from its direct neighbor (address−1).

Considering the ring chain topology 500b, the communication circuitry 514 of a secondary node may generate (534) the own response message 526(X) and cause a transmission of the own response message 526(X) to the primary node 504 concurrently to the forwarding 532 of the broadcast readout message 518 to the subsequent node. For example, the communication circuitry 514 may generate/transmit the own response message 526(X) prior to forwarding the broadcast readout message 518, to ensure sufficient time for the own response message 526(X) to propagate before the subsequent node generates/transmits its own response. As another example, the communication circuitry 514 may generate/transmit the own response message 526(X) after having forwarded the broadcast readout message 518, to enable a faster addressing of all the secondary nodes 506.

In the linear topology 500a the broadcast readout message 518 propagates through the entire chain before any response message 526 is generated. For example, the broadcast readout message 518 may include instructions prompting the secondary nodes 506 to enter an operation mode in which they will carry out the method 520 upon receiving/forwarding response messages 526 from the preceding nodes 506.

As seen from the perspective of the method 520, the method 520 may include receiving, at a secondary node 506, a response message 526 generated by another secondary node 506 and to be forwarded in direction of the primary node 504. The method 520 may further include, determining (e.g., evaluating) at the secondary node 506 whether the response message 526 to be forwarded was generated by the immediately adjacent secondary node 506 in the chain of secondary nodes 506. The method 520 may further include generating by the secondary node 506, an own response message 526(X) if the response message 526 to be forwarded was generated by the immediately adjacent secondary node 506 (or forwarding the response message 526 if the response message 526 to be forwarded was generated by a secondary node 506 other than the immediately adjacent secondary node 506). The own response message 526(X) may be addressed to the primary node 504, and the method 520 may further include causing by the secondary node 506 a transmission of the own response message 526(X) to the primary node 504.

According to various aspects, a computer program product may be provided. The computer program product may store instructions which, when executed by a computer system (e.g., by the processor of the communication circuitry of a secondary node) cause the computer system to carry out the steps of the method 520. For example, the computer program product may be a non-transitory computer readable medium, e.g. part of a secondary node.

FIG. 6A and FIG. 6B show message flow diagrams 600a, 600b illustrating the “serial readout with many responses”. The message flow diagrams 600a, 600b illustrate a scenario in which a primary node 604 transmits a broadcast readout message 618 with a broadcast readout command to prompt a plurality of response messages 626 from a plurality of secondary nodes 606, and possible actions carried out by the secondary nodes 606 in this context. The message flow diagram 600a is related to the linear daisy chain topology, and the message flow diagram 600b is related to the ring daisy chain topology.

As shown in the flow diagram 600a, in the linear topology the primary node 604 may send the multi-response message 618 to the final node 606-N in the chain. The final node 606-N in the chain may generate (634) the own response message 626(N) and cause a propagation of the own response message 626(N) along the daisy chain towards the primary node 604. Each secondary node 606 may generate the own response message after having forwarded the response messages of each preceding node (illustratively, of each node located closer to the final node with respect to the current node). Thus, the second secondary node 606-2 may generate/transmit the own response message 626(2) after having forwarded the response message of the final node 606-N and of each further node between the second secondary node 606-2 and the final node 606-N. The first secondary node 606-1 may generate/transmit the own response message 626(1) after having forwarded the response message of the second node 606-2, etc.

As shown in the flow diagram 600b, in the ring topology the primary node 604 may send the multi-response message 618(1) to the first node 606-1 in the chain. The first node 606-1 in the chain may generate (634) the own response message 626(1) and transmit the own response message 626(1) to the primary node 604 and forward the multi-response message 618(2) to the second node 606-2. The second node 606-2 in the chain may generate (634) the own response message 626(2) and cause propagation of the own response message 626(2) to the primary node 604 and forward the multi-response message 618(N) down the chain until the final node 606-N is reached. The final node 606-N may generate (634) the own response message 626(N) and transmit the own response message 626(N) to the primary node 604.

The following examples pertain to aspects of the present disclosure.

Example 1 is a serial communication network, including: a plurality of network nodes including a primary node and a plurality of secondary nodes, wherein the plurality of network nodes are connected in a daisy chain configuration, wherein the plurality of network nodes are configured to communicate with one another according to a wired communication protocol for serial communication; wherein the primary node comprises control circuitry configured to: generate a broadcast readout message comprising a broadcast readout command to prompt a single response from the plurality of secondary nodes; and cause a transmission of the broadcast readout message along the daisy chain of secondary nodes; wherein each secondary node of the plurality of secondary nodes comprises communication circuitry configured to: receive the broadcast readout message; and if a stop condition associated with the broadcast readout command is fulfilled at the secondary node, generate a response message addressed to the primary node and cause a transmission of the response message to the primary node via the daisy chain of secondary nodes.

In Example 2, the serial communication network according to example 1 may optionally further include that the communication circuitry of the secondary node is further configured to refrain from generating the response message and forward the broadcast readout message to an adjacent secondary node in the daisy chain of secondary nodes if the stop condition associated with the broadcast readout message is not fulfilled at the secondary node.

In Example 3, the serial communication network according to example 2 may optionally further include that the communication circuitry of the secondary node is further configured to modify or add information of the broadcast readout message prior to forwarding the broadcast readout message to the adjacent secondary node.

In Example 4, the serial communication network according to any one of examples 1 to 3 may optionally further include that the communication circuitry of the secondary node is further configured to receive a response message addressed to the primary node; and forward the response message in direction of the primary node along the daisy chain of secondary nodes.

In Example 5, the serial communication network according to example 4 may optionally further include that the communication circuitry of the secondary node is further configured to modify the response message prior to forwarding the response message in direction of the primary node by replacing first information contained in the response message and associated with another secondary node with own second information associated with the secondary node.

In Example 6, the serial communication network according to example 5 may optionally further include that the first information comprises a first value of an operating parameter of the other secondary node; and that the second information comprises a second value of the operating parameter of the secondary node.

In Example 7, the serial communication network according to any one of examples 1 to 6 may optionally further include that the stop condition comprises one or more of: reaching of an end of line of the daisy chain of secondary nodes; and/or a stop event being pending at the secondary node.

In Example 8, the serial communication network according to any one of examples 1 to 7 may optionally further include that the wired communication protocol for serial communication is the Open System Protocol (OSP).

Example 9 is a method of serial broadcast readout in a serial communication network, wherein the serial communication network includes a plurality of network nodes comprising a primary node and a plurality of secondary nodes, wherein the plurality of network nodes are connected in a daisy chain configuration, wherein the plurality of network nodes are configured to communicate with one another according to a wired communication protocol for serial communication; wherein the method includes: receiving, at a secondary node, a broadcast readout message generated by the primary node, the broadcast readout message including a broadcast readout command configured to prompt a single response from the plurality of secondary nodes; determining at the secondary node whether a stop condition associated with the broadcast readout command is fulfilled; and if the stop condition is fulfilled, generating, by the secondary node, a response message, and causing a transmission of the response message to the primary node.

Example 10 is a serial communication network, including: a plurality of network nodes comprising a primary node and a plurality of secondary nodes, wherein the plurality of network nodes are connected to one another in a daisy chain configuration, wherein the plurality of network nodes are configured to communicate with one another according to a wired communication protocol for serial communication; wherein the primary node includes control circuitry configured to: generate a broadcast readout message comprising a broadcast readout command to prompt a respective response from each of the plurality of secondary nodes; and cause a transmission of the broadcast readout message to a boundary secondary node disposed at a boundary of the daisy chain of secondary nodes; wherein each secondary node includes communication circuitry configured to: receive a response message to the broadcast readout message generated by another secondary node, wherein the response message is to be forwarded to the primary node; and if the response message to be forwarded was generated by an immediately adjacent secondary node in the daisy chain of secondary nodes, generate an own response message and cause a transmission of the own response message to the primary node after having forwarded the response message of the immediately adjacent secondary node.

In Example 11, the serial communication network according to example 10 may optionally further include that the communication circuitry of the secondary node is further configured to refrain from generating the own response message and forward the response message in direction of the primary node if the response message was generated by a secondary node other than the immediately adjacent secondary node.

In Example 12, the serial communication network according to example 10 or 11 may optionally further include that the daisy chain configuration has a linear topology and the boundary secondary node is the last secondary node of the daisy chain of secondary nodes; or that the daisy chain configuration has a ring topology and the boundary secondary node is the initial secondary node of the daisy chain of secondary nodes.

In Example 13, the serial communication network according to any one of examples 10 to 12 may optionally further include that at least one secondary node includes one or more light emitting elements and a driver circuit for driving the one or more light emitting elements.

In Example 14, the serial communication network according to any one of examples 10 to 13 may optionally further include that the wired communication protocol for serial communication is the Open System Protocol (OSP).

Example 15 is a method of serial broadcast readout in a serial communication network, wherein the serial communication network includes a plurality of network nodes comprising a primary node and a plurality of secondary nodes, wherein the plurality of network nodes are connected in a daisy chain configuration, wherein the plurality of network nodes are configured to communicate with one another according to a wired communication protocol for serial communication; wherein the method includes: receiving, at a secondary node, a response message generated by another secondary node and to be forwarded in direction of the primary node in response to a broadcast readout message from the primary node; determining at the secondary node whether the response message to be forwarded was generated by the immediately adjacent secondary node in the chain of secondary nodes; and if the response message to be forwarded was generated by the immediately adjacent secondary node, generating by the secondary node, an own response message and causing a transmission of the own response message to the primary node after having forwarded the response message of the immediately adjacent secondary node.

The terms “processor” or “control circuitry” as used herein may be understood as any kind of technological entity that allows handling of data. The data may be handled according to one or more specific functions that the processor/control circuitry may execute. Further, a processor/control circuitry as used herein may be understood as any kind of circuit, e.g., any kind of analog or digital circuit. A processor/control circuitry may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processor/control circuitry detailed herein may be realized as a single entity with equivalent functionality or the like, and conversely that any single processor/control circuitry detailed herein may be realized as two (or more) separate entities with equivalent functionality or the like.

The term “connected” may be used herein with respect to terminals, integrated circuit elements, devices, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, devices, regions, contacts, etc., may be understood as an electrically conductive connection with, for example, ohmic behavior, e.g. provided by a metal or degenerate semiconductor in absence of p-n junctions in the current path. The term “coupled” may be used herein in the same manner as the term “connected”.

The term “terminal” may be used herein to describe a location (e.g., a point) or structure of a device or of an element of the device at which a signal (e.g., an analog signal, for example a current or a voltage) may be provided and/or to which another device or element may be connected. Illustratively, a terminal may be a location or a structure that is electrically conductively connected with the device or the element. A terminal may also be referred to herein as port, pin, contact, or contact point.

The terms “path”, “electrical path”, or “electrically conductive path” may be used herein to describe an electrically conductive connection between two or more elements. A path may be understood, in some aspects, as an electrically conductive line (or trace) along which a signal (in some aspects, a current or a voltage) may travel, e.g. from a first element connected to the path to a second element connected to the path or vice versa. The term path may describe a direct path or an indirect path, wherein an indirect path may only include additional structures in the path that do not influence the substantial functioning of the described circuit or device (illustratively, that do not influence the signal traveling along the path).

As used herein, a signal that is “indicative of”, “representative of” or “representing” a value or other information (e.g., an instruction) may be a digital or analog signal that encodes or otherwise communicates the value or other information in a manner that can be decoded by and/or cause a responsive action in a component receiving the signal (e.g., in a secondary device receiving instructions from a primary device, or in a primary device receiving data from a secondary device).

As used herein, “memory” is understood as a computer-readable medium (e.g., a non transitory computer readable medium) in which data or information can be stored for retrieval. References to “memory” included herein may thus be understood as referring to volatile or non volatile memory, including random access memory (RAM), read only memory (ROM), flash memory, solid state storage, magnetic tape, hard disk drive, optical drive, among others, or any combination thereof. Registers, shift registers, processor registers, data buffers, among others, are also embraced herein by the term memory.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

Unless specified otherwise, the term “subset” in relation to a group of elements may be understood to include a numerical quantity equal to or greater than one and less than a total number of the implied elements. Considering for example a group of ten elements, a “subset” of the group may include one, two, three, four, five, six, seven, eight, or nine elements. The term “subset” in relation to a group may thus describe a “proper subset” of the group, so that all the elements of the subset belong to the group, but at least one element of the group does not belong to the subset.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

List of reference signs

| | |
|---|---|
| 100 | Serial communication network |
| 100a | Network topology |
| 100b | Network topology |
| 102 | Network node |
| 104 | Primary node |
| 106a | Secondary node |
| 106b | Secondary node |
| 106c | Secondary node |
| 106d | Secondary node |
| 108 | Control circuitry |
| 110 | Wired connection |
| 112 | Communication circuitry |
| 200 | Network node |
| 200b | Network node |
| 200c-1 | Network node |
| 200c-2 | Network node |
| 200d | Network node |
| 202 | Communication circuitry |
| 204 | Functional circuitry |
| 204b | Functional circuitry |
| 206 | Input/output port |
| 206c | Input/output port |
| 208 | Input/output port |
| 208c | Input/output port |
| 210 | Driver circuit |
| 212 | Light emitting elements |
| 214 | Input/output pin |
| 216 | Input/output pin |
| 218 | Input/output pin |
| 220 | Input/output pin |
| 222 | Electrically conductive line |
| 224 | Electrically conductive line |
| 226 | Electrically conductive line |
| 228 | Electrically conductive line |
| 230 | Resistor arrangement |
| 232 | Resistor arrangement |
| 234 | Supply terminal |
| 236 | Ground terminal |
| 238 | Communication hardware |
| 240 | Processor |
| 300 | Serial communication network |
| 300a | Network topology |
| 300b | Network topology |
| 302 | Network nodes |
| 304 | Primary node |
| 306 | Secondary nodes |
| 306a | Secondary node |
| 306b | Secondary node |
| 306c | Secondary node |
| 306d | Secondary node |
| 308 | Control circuitry |
| 310 | Wired connection |
| 312 | Communication circuitry |
| 314 | Communication circuitry |
| 318 | Broadcast readout message |
| 320 | Method |
| 322 | Stop condition |
| 324 | Forwarding |
| 326 | Response message |
| 400a | Message flow diagram |
| 400b | Message flow diagram |
| 400c | Message flow diagram |
| 404 | Primary node |
| 406 | Secondary nodes |
| 406-1 | First secondary node |
| 406-2 | Second secondary node |
| 406-N | N-th secondary node |
| 418 | Broadcast readout message |
| 418(1) | First modified broadcast readout message |
| 418(1 + 2) | Second modified broadcast readout message |
| 424 | Forwarding |
| 426 | Response message |
| 426(N) | First response message |
| 426(N + 2) | Second response message |
| 426(N + 2 + 1) | N-th response message |
| 428 | Response generation |
| 430 | Modification of broadcast readout message |
| 432 | Modification of response message |
| 500 | Serial communication network |
| 500a | Network topology |
| 500b | Network topology |
| 502 | Network nodes |
| 504 | Primary node |
| 506 | Secondary nodes |
| 506a | Secondary node |
| 506b | Secondary node |
| 506c | Secondary node |
| 506d | Secondary node |
| 508 | Control circuitry |
| 510 | Wired connection |
| 512 | Communication circuitry |
| 514 | Communication circuitry |
| 518 | Broadcast readout message |
| 520 | Method |
| 526 | Broadcast response message |
| 526(X) | Own broadcast response message |
| 530 | Determination |
| 532 | Forwarding |
| 534 | Generation of own response message |
| 600a | Message flow diagram |
| 600b | Message flow diagram |
| 604 | Primary node |
| 606 | Secondary nodes |
| 606-1 | First secondary node |
| 606-2 | Second secondary node |
| 606-N | N-th secondary node |
| 618 | Broadcast readout message |
| 618(1) | First broadcast readout message |
| 618(2) | Second broadcast readout message |
| 618(N) | N-th broadcast readout message |
| 626 | Response message |
| 626(1) | First response message |
| 626(2) | Second response message |
| 626(N) | N-th response message |
| 634 | Generation of own response message |

1. A serial communication network, comprising:
a plurality of network nodes comprising a primary node and a plurality of secondary nodes,
wherein the plurality of network nodes are connected in a daisy chain configuration,
wherein the plurality of network nodes are configured to communicate with one another according to a wired communication protocol for serial communication;
wherein the primary node comprises control circuitry configured to:
generate a broadcast readout message comprising a broadcast readout command to prompt a single response from the plurality of secondary nodes; and
cause a transmission of the broadcast readout message along the daisy chain of secondary nodes;
wherein each secondary node of the plurality of secondary nodes comprises communication circuitry configured to:
receive the broadcast readout message; and
if a stop condition associated with the broadcast readout command is fulfilled at the secondary node, generate a response message addressed to the primary node and cause a transmission of the response message to the primary node via the daisy chain of secondary nodes,
wherein the communication circuitry is further configured to receive the response message addressed to the primary node; and forward the response message in direction of the primary node along the daisy chain of secondary nodes,
wherein the communication circuitry is further configured to modify the response message prior to forwarding the response message in direction of the primary node by replacing first information contained in the response message and associated with another secondary node with own second information associated with the secondary node.

2. The serial communication network according to claim 1,
wherein the communication circuitry of the secondary node is further configured to refrain from generating the response message and forward the broadcast readout message to an adjacent secondary node in the daisy chain of secondary nodes if the stop condition associated with the broadcast readout message is not fulfilled at the secondary node.

3. The serial communication network according to claim 2,
wherein the communication circuitry of the secondary node is further configured to modify or add information of the broadcast readout message prior to forwarding the broadcast readout message to the adjacent secondary node.

4. The serial communication network according to claim 1,
wherein the communication circuitry of the secondary node is configured to modify the response message by replacing the first information with the own second information if the own second information fulfills a replacement criterion.

5. The serial communication network according to claim 1,
wherein the first information comprises a first value of an operating parameter of the other secondary node; and
wherein the second information comprises a second value of the operating parameter of the secondary node.

6. The serial communication network according to claim 5,
wherein the replacement criterion comprises the first value of the operating parameter of the other secondary node being greater than the second value of the operating parameter of the secondary node; or
wherein the replacement criterion comprises the first value of the operating parameter of the other secondary node being less than the second value of the operating parameter of the secondary node.

7. The serial communication network according to claim 1,
wherein the stop condition comprises one or more of: reaching of an end of line of the daisy chain of secondary nodes; and/or a stop event being pending at the secondary node.

8. The serial communication network according to claim 1,
wherein the wired communication protocol for serial communication is the Open System Protocol.

9. (canceled)

10. A serial communication network, comprising:
a plurality of network nodes-comprising a primary node and a plurality of secondary nodes,
wherein the plurality of network nodes are connected to one another in a daisy chain configuration,
wherein the plurality of network nodes are configured to communicate with one another according to a wired communication protocol for serial communication;
wherein the primary node-comprises control circuitry configured to:
generate a broadcast readout message-comprising a broadcast readout command to prompt a respective response from each of the plurality of secondary nodes; and
cause a transmission of the broadcast readout message to a boundary secondary node disposed at a boundary of the daisy chain of secondary nodes;
wherein each secondary node comprises communication circuitry configured to:
receive a response message to the broadcast readout message generated by another secondary node, wherein the response message is to be forwarded to the primary node; and
if the response message to be forwarded was generated by an immediately adjacent secondary node in the daisy chain of secondary nodes, generate an own response message and cause a transmission of the own response message to the primary node after having forwarded the response message of the immediately adjacent secondary node,
wherein the communication circuitry is further configured to refrain from generating the own response message and forward the response message direction of the primary node if the response message was generated by a secondary node other than the immediately adjacent secondary node.

11. The serial communication network according to claim 10,
wherein the daisy chain configuration has a linear topology and the boundary secondary node is the last secondary node of the daisy chain of secondary nodes; or
wherein the daisy chain configuration has a ring topology and the boundary secondary node is the initial secondary node of the daisy chain of secondary nodes.

12. The serial communication network according to claim 10,
wherein at least one secondary node comprises one or more light emitting elements and a driver circuit for driving the one or more light emitting elements.

13. The serial communication network according to claim 10,
wherein the wired communication protocol for serial communication is the Open System Protocol.

14. (canceled)

15. A serial communication network, comprising:
a plurality of network nodes comprising a primary node and a plurality of secondary nodes,
wherein the plurality of network nodes are connected to one another in a daisy chain configuration,
wherein the plurality of network nodes are configured to communicate with one another according to a wired communication protocol for serial communication;
wherein the primary node comprises control circuitry configured to:
generate a broadcast readout message comprising a broadcast readout command to prompt a respective response from each of the plurality of secondary nodes; and
cause a transmission of the broadcast readout message to a boundary secondary node disposed at a boundary of the daisy chain of secondary nodes;
wherein each secondary node comprises communication circuitry configured to:
receive the broadcast readout message from a preceding secondary node in the daisy chain of secondary nodes;
generate an own response message to the broadcast readout message and cause a transmission of the own response message towards the primary node; and
after having caused the transmission of the own response message towards the primary node, forwarding the broadcast readout message to the following secondary node in the daisy chain of secondary nodes.
